(19) United States
(12) Patent Application Publication
(10) Pub. No.: US 2012/0051540 A1
(43) Pub. Date: Mar. 1, 2012

(54) CONDITIONAL ACCESS SYSTEM AND METHOD OF USING CONDITIONAL ACCESS IMAGE

(75) Inventors: Jin Young MOON, Daejeon (KR); Jong Youl Park, Daejeon (KR); Eui Hyun Paik, Daejeon (KR); Dong Won Han, Daejeon (KR)

(73) Assignee: Electronics and Telecommunications Research Institute, Daejeon (KR)

(21) Appl. No.: 13/211,820

(22) Filed: Aug. 17, 2011

(30) Foreign Application Priority Data
Aug. 24, 2010 (KR) 10-2010-0082082

(51) Int. Cl. H04N 7/167

(52) U.S. Cl. 380/200

(57) ABSTRACT

Provided are a conditional access system and a method of using a conditional access image. The conditional access system according to an exemplary embodiment of the present invention includes: a service key management client allocated with a service key from a service key management server using a service key distribution protocol; a download client downloading a conditional access image using the service key and requesting updating the service key to the service key management server through the service key management client when the downloading is completed; and an execution controller encrypting and storing the conditional access image using the service key updated in accordance with the request and recovering the conditional access image using the service key reacquired through the service key management client before executing the stored conditional access image.

### CROSS-REFERENCE TO RELATED APPLICATIONS

This application claims priority under 35 U.S.C. §119 to Korean Patent Application No. 10-2010-0082082, filed on Aug. 24, 2010, in the Korean Intellectual Property Office, the disclosure of which is incorporated herein by reference in its entirety.

### TECHNICAL FIELD

The present invention relates to a conditional access system, and more particularly, to a conditional access system and a method of using a conditional access image which can easily detect the thieving of an authority of a conditional access image.

### BACKGROUND

In recent years, as software products which are easy to illegally copy as compared with hardware increase, software producers take pains to prepare a countermeasure for protecting a software copyright.

Representatively, there is a method disabling execution of illegally copied software using an embedded code (i.e., a serial number). However, this method is useful to a software thief who is not skillful but merely delays illegal copy speed to skillful software hackers.

In recent years, contents of television, Internet, mobile, and the like are widely used as the software products and the contents are difficult to further protect than general software. Therefore, a television system adopts a contents security solution that is, a conditional access system in order to protect contents of pay channels.

The related art of conditional access system is constituted by a headend providing A/V, a terminal using A/V, and the like as shown in FIG. 1. Hereinafter, each component will be described.

The headend includes a scrambler scrambling A/V and a key encryption module encrypting a control word. The headend encrypts the control word with an authentication key for security and transmits the encrypted control word through an entitlement control message and encrypts an authorization key using a subscriber secret key (that is, a private key of a subscriber) and thereafter, transmits the encrypted authentication key through an entitlement management message. In this case, the entitlement management message and the entitlement control message are generated in subscription and unsubscription of the subscriber, the subscriber secret key is distributed from a subscriber management system and stored in a smart card.

The terminal includes a key management module decoding the control word and a descrambler descrambling scrambled contents using the decoded control word. When the terminal receives the entitlement control message and the entitlement management message, the terminal verifies a message and thereafter, decodes the control word in a reverse order to the order performed in the headend. That is, the terminal decodes the authentication key using the subscriber secret key embedded in the smart card and decodes the control word using the authentication key and uses it for descrambling.

However, since the related art of conditional access system is a hardware device or a hardware-based conditional access system mounted in an embedded form in the smart card or the terminal, it is difficult to replace or change and upgrade.

In order to solve the problem, a software-based conditional access system which can support the terminal to execute only a valid conditional access image using a conditional access image processing the conditional access message is proposed.

However, the software-based conditional access system has a problem in that the conditional access image is driven even in the copied terminal as well as the authorized terminal. Therefore, it is urgent to solve the problem.

### SUMMARY

An exemplary embodiment of the present invention provides a conditional access system that includes: a service key management client allocated with a service key from a service key management server using a service key distribution protocol; a download client downloading a conditional access image using the service key and requesting updating the service key to the service key management server through the service key management client when the downloading is completed; and an execution controller encrypting and storing the conditional access image using the service key updated in accordance with the request and recovering the conditional access image using the service key reacquired through the service key management client before executing the stored conditional access image.

Another exemplary embodiment of the present invention provides a conditional access system that includes: a terminal that downloads a conditional access image using a service key 1, when the downloading the conditional access image is completed, requests the updating the service key 1, and encrypts and stores the conditional access image using a service key 2 resulting the updating; and a headend that transmits a service key 3 which is being used in accordance with a request, transmits the conditional access image to a terminal that requests the conditional access image using the service key 3, and updates the service key 3 which is being used in accordance with the request from the terminal.

Yet another exemplary embodiment of the present invention provides a method of using a conditional access image that includes: requesting the conditional access image using a service key 1 acquired from a service key management server and downloading the conditional access image; requesting updating the service key 1 when the downloading is completed; encrypting and storing the conditional access image using a service key 2 acquired by updating the service key 1; and reacquiring a service key 3 from the service key management server to recover the conditional access image, before executing the conditional access image.

Still another exemplary embodiment of the present invention includes: a download server downloading a conditional access image to a terminal; and a service key management server providing a service key to the terminal and updating the service key in accordance with a request from the terminal downloading the conditional access image, wherein the service key management server uses different service keys whenever downloading the conditional access image.

Other features and aspects will be apparent from the following detailed description, the drawings, and the claims.

### BRIEF DESCRIPTION OF THE DRAWINGS

FIG. 1 is a configuration diagram showing a related art of conditional access system;

FIG. 2 is a configuration diagram showing a conditional access system applied to an IPTV system according to an exemplary embodiment of the present invention;

FIGS. 3 and 4 are diagrams showing a service key distribution method according to an exemplary embodiment of the present invention; and

FIG. 5 is a diagram showing a method of using a conditional access image according to an exemplary embodiment of the present invention.

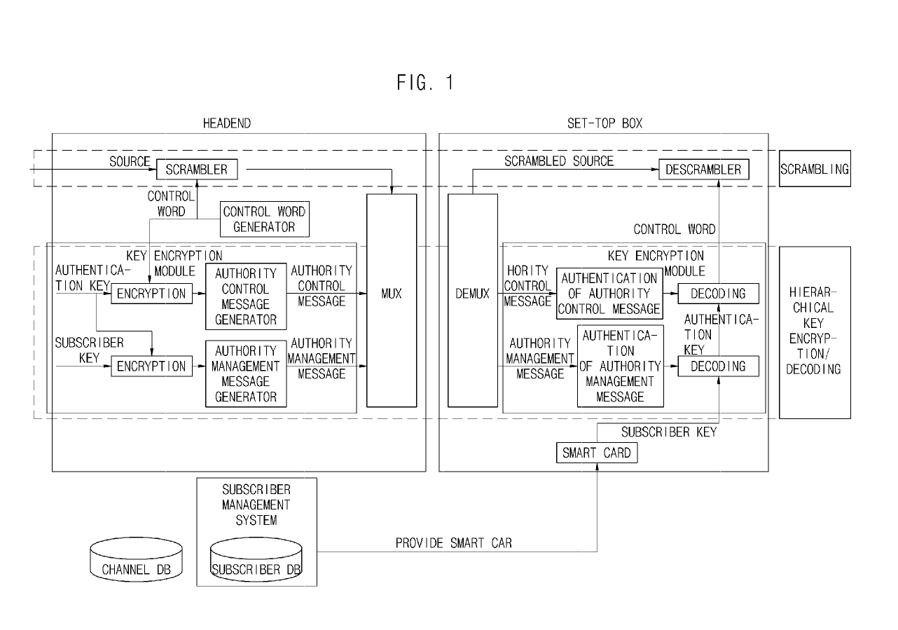

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, exemplary embodiments of the present invention will be described in detail with reference to the accompanying drawings.

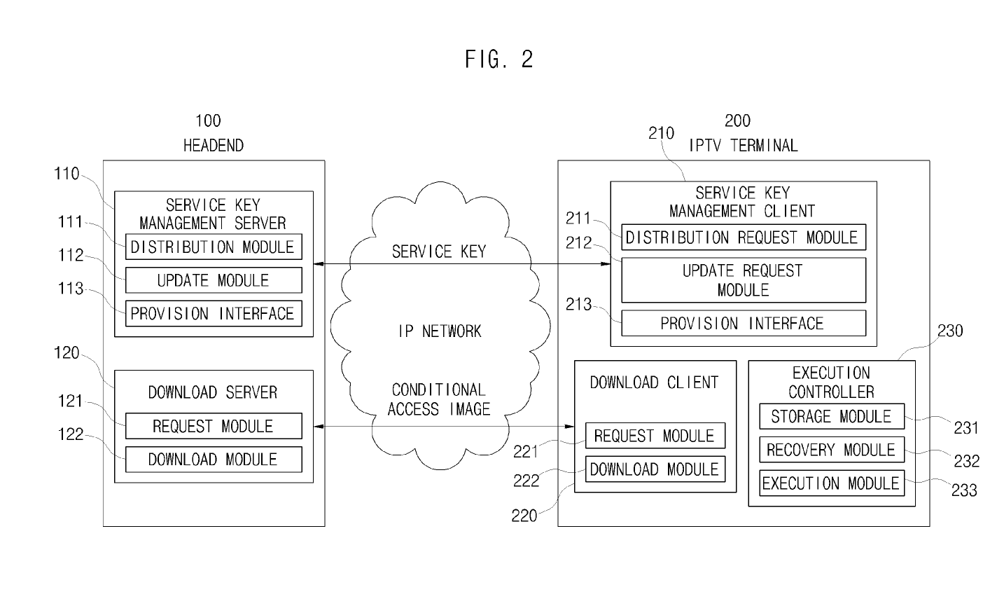

FIG. 2 is a configuration diagram showing a conditional access system applied to an IPTV system according to an exemplary embodiment of the present invention.

As shown in FIG. 2, the conditional access system 10 according to the exemplary embodiment of the present invention includes a headend 100 and an IPTV terminal 200.

The headend 100 includes a service key management server 110 distributing and updating a service key and a download server 120 transferring a conditional access image to an IPTV terminal 200 through an IP network in accordance with a request of the IPTV terminal 200.

The service key management server 110 includes a provision interface 113 that receives a request for a service key from each system in the headend 100 and provides the service key being used in response to the request, a distribution module 111 that provides the service key in accordance with a service key distribution request of the IPTV terminal 200, and an update module 112 providing a service key which is updated in accordance with a service key update request of the IPTV terminal 200.

The IPTV terminal 200 includes a service key management client 210, a download client 220, and an execution controller 230.

The service key management client 210 downloads the service key from the service key management server 110 and provides it the execution controller 230.

The service key management client 210 includes a provision interface 213, a distribution request module 211, and an update request module 212. Hereinafter, each component will be described.

The provision interface 213 provides the service key acquired in accordance with the requests of the download client 220 to the execution controller 230.

When the distribution request module 211 receives the service key distribution request through the provision interface 213, the distribution request module 211 requests the distribution of the service key to the service key management server 110, and receives the service key distributed from the service key management server 110 and provides the service key to the provision interface 213.

When the update request module 212 receives the request for the service key update from the execution controller 230 through the provision interface 213, the update request module 212 requests the service key update to the service key management server 110, and receives the service key updated in response to the request and provides the corresponding service key to the execution controller 230 through the provision interface 213.

The download client 220 downloads the conditional access image and provides it to the execution controller 230 in accordance with a download protocol.

The execution controller 230 encrypts and stores the downloaded conditional access image using the updated service key. In this case, when a storage module 231 of the execution controller 230 completes the storing of the service key, the storage module 231 deletes the service key used in encryption in order to prevent the conditional access image from being copied and used.

The execution controller 230 reacquires a final service key which is being used from the service key management server 110 through the service key management client 210 before executing the conditional access image, a recovery module 232 recovers the conditional access image using the final service key, and an execution module 233 executes the recovered conditional access image.

In this case, the execution controller 230 recovers and executes the conditional access image if the reacquired final service key is the same as the service key used for storage.

On the contrary, the execution controller 230 determines that the authority of the conditional access image is thieved if the reacquired final service key is different from the service key used for storage and may notify it to a user.

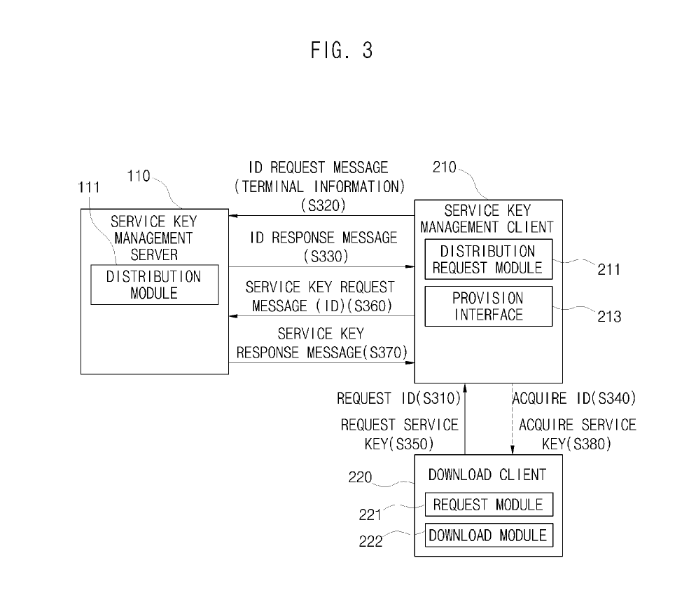

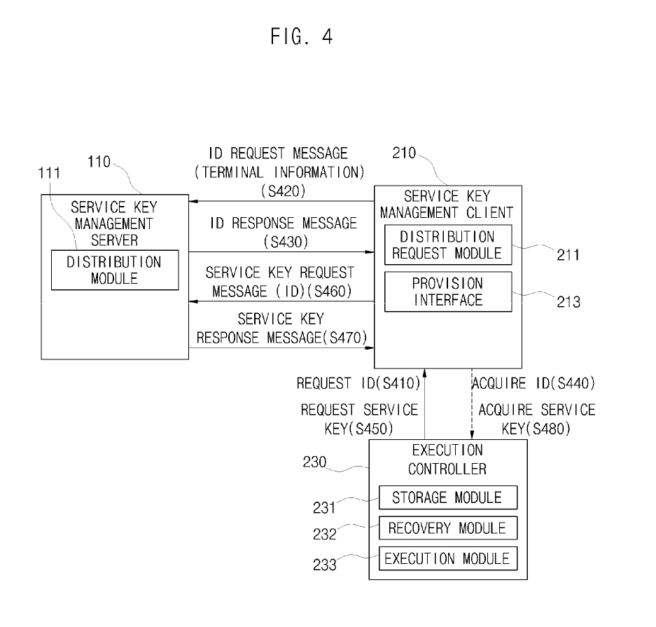

Hereinafter, referring to FIGS. 3 and 4, a service key distribution method according to an exemplary embodiment of the present invention will be described. FIGS. 3 and 4 are diagrams showing a service key distribution method according to an exemplary embodiment of the present invention.

Referring to FIG. 3, a download client 220 requests an ID required to a service key request to a service key management client 210 (S310) and the service key management client 210 transmits an ID request message including terminal information to a service key management server 110 and requests the ID (S320).

Subsequently, the service key management server 110 transmits an ID response message including the ID to the service key management client 210 (S330) and the service key management client 210 verifies the ID from the ID response message and transmits the verified ID to the download client 220 (S340).

Next, the download client 220 requests a service key to the service key management client 210 using the acquired ID (S350) and the service key management client 210 transmits a service key request message including the ID to the service key management server 110 and requests the service key (S360).

The service key management server 110 transmits a service key response message including the service key in response to the corresponding request (S370) and the service key management client 210 transmits the service key acquired from the service key response message to the download client 220 (S380).

In FIG. 3, the process of exchanging the messages between the service key management server 110 and the service key management client 210 for acquiring the ID and the service key is also referred to as a service key distribution protocol.

Meanwhile, the key distribution method of FIG. 3 may be similarly applied even to other sub-systems in the terminal requiring the service key in addition to the download client 220.

FIG. 4 shows such an example. As shown in FIG. 4, even when an execution controller 230 is implemented to additionally request and acquire the service key for the security reason, the service key may be acquired through the same procedure as above.

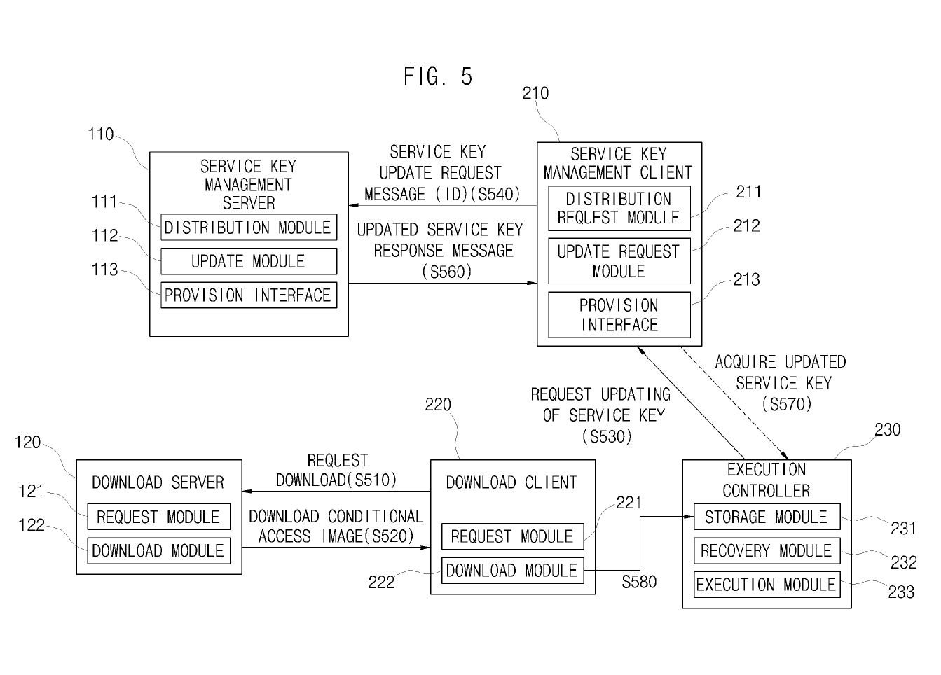

Hereinafter, referring to FIG. 5, a method for an execution controller to recover and execute a conditional access image using the service key acquired through the processes of FIGS. 3 and 4 will be described. FIG. 5 is a diagram showing a method of using a conditional access image according to an exemplary embodiment of the present invention.

Referring to FIG. 5, a download client 220 requests the conditional access image to a download server 120 using a service key #1 (S510) and the download server 120 transmits the conditional access image to the download client 220 in response to the corresponding request (S520).

In this case, the download server 120 may encrypt and transmit the conditional access image using the service key #1 for safe transmission and the download client 220 may download the conditional access image using the service key #1.

In this case, the download server 120 may transmit the conditional access image only when a currently used service key is the same as the transmitted service key #1.

The execution controller 230 requests the updating a service key to a service key management client 210 in order to safely store the conditional access image downloaded by the download client 220 in a storage module 231 (S530).

The service key management client 210 transmits a service key update request message including an ID of an IPTV terminal 200 to the service key management server 110 in accordance with the service key update request (S540).

The service key management server 110 updates the service key #1 to a service key #2 (S550) and transmits a service key response message including the service key #2 to the service key management client 210 (S560). Herein, the service key management server 110 also transmits the service key #2 to the download server 120 and thereafter, may allow the download server 120 to verify the service key #2 and determine whether or not to download the conditional access image.

Subsequently, the service key management client 210 extracts the service key #2 from the service key response message and provides the extracted service key #2 to the execution controller 230 (S570).

The execution controller 230 encrypts the conditional access image received from the download client 220 using the service key #2 and stores the encrypted conditional access image in the storage module 231 (S580). In this case, the execution controller 230 removes the service key #2 when the encryption ends.

Thereafter, the execution controller 230 again requests the service key #2 to the service key management server 110 through the service key management client 210 in order to execute the conditional access image, and recovers and executes the conditional access image using the service key #2.

On the other hand, when another IPTV terminal (not shown) reloads the conditional access image from the download server 120 using the service key #2, the service key #2 is updated to a service key #3 through the process of FIG. 5.

In this case, the IPTV terminal 200 that stores the conditional access image encrypted by the service key #2 cannot recover and execute the stored conditional access image any longer and only another IPTV terminal (not shown) that lastly downloads the conditional access image may execute the conditional access image.

If another IPTV terminal (not shown) is a copy terminal which a user of the IPTV terminal 200 does not know, the IPTV terminal 200 notifies that its own ID is thieved to the user or a service manager to take measures including the tracking the copy terminal, and the like.

As described above, according to exemplary embodiment of the present invention, since a service key is changed whenever a conditional access image is downloaded, an execution right of the conditional access image can be allocated to only one terminal which performs final downloading of the conditional access image.

In addition, since the execution right of the conditional access image is allocated to only one terminal, thieving authority of the conditional access image can be easily determined and connected to follow-up measures.

Further, since a software-based conditional access system is used, upgrade, replacement, and alternation may be easy.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A conditional access system, comprising:
a service key management client allocated with a service key from a service key management server using a service key distribution protocol;
a download client downloading a conditional access image using the service key and requesting updating the service key to the service key management server through the service key management client when the downloading is completed; and
an execution controller encrypting and storing the conditional access image using the service key updated in accordance with the request and recovering the conditional access image using the service key reacquired through the service key management client before executing the stored conditional access image.

2. The system of claim 1, wherein the execution controller verifies whether the reacquired service key is the same as the updated service key and when both keys are the same as each other, recovers the conditional access image.

3. The system of claim 2, wherein the execution controller notifies that a use authority of the conditional access image is thieved to a user when the reacquired service key is different from the updated service key.

4. The system of claim 1, wherein the execution controller deletes the updated service key used for encryption when the storing of the conditional access image is completed.

5. A conditional access system, comprising:
a terminal that downloads a conditional access image using a service key 1, when the downloading the conditional access image is completed, requests the updating the service key 1, and encrypts and stores the conditional access image using a service key 2 resulting the updating; and
a headend that transmits a service key 3 which is being used in accordance with a request, transmits the conditional access image to a terminal that requests the conditional access image using the service key 3, and updates the service key 3 which is being used in accordance with the request from the terminal.

6. The system of claim 5, wherein when the storing of the conditional access image is completed, the terminal deletes the service key 2.

7. The system of claim 5, wherein the terminal acquires the service key 3 making a request to the headend and attempts to recover the conditional access image using the service key 3, before executing the conditional access image.

8. The system of claim 7, wherein the terminal recovers and executes the conditional access image when the service key 3 is the same as the service key 2 used for encryption.

9. The system of claim 7, wherein the terminal does not recover the conditional access image and notifies that an authority of the conditional access image is thieved to a user when the service key 3 is different from the service key 2.

10. The system of claim 5, further comprising:
another terminal that requests the downloading the conditional access image and requests updating the service key 3 at the time of downloading the conditional access image,
wherein when the service key 3 is updated by the another terminal, the terminal does not recover the conditional access image.

11. A method of using a conditional access image, comprising:
requesting the conditional access image using a service key 1 acquired from a service key management server and downloading the conditional access image;
requesting updating the service key 1 when the downloading is completed;
encrypting and storing the conditional access image using a service key 2 acquired by updating the service key 1; and
reacquiring a service key 3 from the service key management server to recover the conditional access image, before executing the conditional access image.

12. The method of claim 11, wherein the recovering includes:
verifying whether the service key 3 is the same as the service key 2; and
recovering and executing the conditional access image when both keys are the same as each other on the basis of the verification result at the verifying.

13. The method of claim 12, wherein the recovering includes notifying that an authority of the conditional access image is thieved to a user when both keys are different from each other on the basis of the verification result at the verifying.

14. The method of claim 12, wherein the recovering detects that the conditional access image is redownloaded and verifies whether the redownloading is performed by a predetermined terminal when both keys are different from each other on the basis of the verification result at the verifying.

15. The method of claim 11, wherein the storing includes deleting the service key 2 used for encryption when the storing the conditional access image is completed.

16. The method of claim 11, wherein the downloading includes:
being allocated with an ID required to request a service key; and
requesting the service key 3 using the allocated ID.

17. The method of claim 11, wherein the downloading includes encrypting and transmitting the conditional access image using the service key 1.

18. A conditional access system, comprising:
a download server downloading a conditional access image to a terminal; and
a service key management server providing a service key to the terminal and updating the service key in accordance with a request from the terminal downloading the conditional access image,
wherein the service key management server uses different service keys whenever downloading the conditional access image.

19. The system of claim 18, wherein the download server encrypts and transmits the conditional access image using the service key transmitted with the request from the terminal.

20. The system of claim 19, wherein the download server transmits the conditional access image when a currently used service key is the same as the service key transmitted.
